(19) United States
(12) Patent Application Publication
(10) Pub. No.: US 2010/0146460 A1
(43) Pub. Date: Jun. 10, 2010

(54) SYSTEM AND METHOD FOR MODIFYING A PLURALITY OF KEY INPUT REGIONS BASED ON DETECTED TILT AND/OR RATE OF TILT OF AN ELECTRONIC DEVICE

(75) Inventor: Gregory A. Dunko, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/331,474

(22) Filed: Dec. 10, 2008

(51) Int. Cl. G06F 3/033

(52) U.S. Cl. 715/863

(57) ABSTRACT

A system, method and computer program that utilizes motion detection circuitry to dynamically update displayed labels on one or more key input regions. In one aspect of the invention, the number of key input regions is substantially less than the number of keys on a conventional QWERTY keypad and the labels on the key input regions dynamically change based on the detected motion of the motion detection circuitry.

### TECHNICAL FIELD OF THE INVENTION

The present invention relates generally to portable electronic devices and, more particularly, to a portable electronic device that utilizes motion detection circuitry to dynamically display user input symbols on key input regions of the device.

### DESCRIPTION OF THE RELATED ART

Mobile and/or wireless electronic devices are becoming increasingly popular. For example, mobile telephones, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces.

There are increasing use and interest in messaging applications for portable electronic devices. In many of these electronic devices a conventional QWERTY keyboard or similar keyboard configuration is desirable. One problem with such devices is that QWERTY keypads tend to be large and may drive the overall size of the portable electronic device beyond a desired form factor.

### SUMMARY

Aspects of the present invention relate to a system, method and computer program that utilizes motion detection circuitry to dynamically update displayed labels on key input regions. In one aspect of the invention, the number of key input regions is substantially less than the number of keys on a conventional QWERTY keypad and the labels on the key input regions dynamically change (also referred to herein as updated) based on the detected motion of the motion detection circuitry. For example, when the electronic device is titled to the right, the key input regions may display user input symbols that are mapped in memory and/or otherwise correspond to the detected tilt (e.g., a detected right tilt may display keys on the key input regions that are located on the right side of a keypad template (e.g., a conventional QWERTY keypad)). When the device is tilted to the left, the key input regions may display keys that are mapped to the left side of the keypad template. As such, conventional keypads may be fully realized with much fewer key input regions than a conventional QWERTY keypad.

One aspect of the invention relates to an electronic device including: a memory for storing user input symbols; a plurality of key input regions that display a subset of the user input symbols available in the memory; motion detection circuitry configured to detect motion of the electronic device and generate an output signal corresponding to the detected motion; and a processor coupled to the motion detection circuitry, the plurality of key input regions and the memory, wherein the processor processes the output signal of the motion detection circuitry and dynamically displays the subset of user input symbols on the plurality of key input regions based on the output signal of the motion detection circuitry.

Another aspect of the invention relates to the motion detection circuitry includes an accelerometer.

Another aspect of the invention relates to the output signal of the motion detection circuitry corresponds to a relative tilt angle of the electronic device.

Another aspect of the invention relates to the output signal of the motion detection circuitry corresponds to a rate of tilt associated with the electronic device.

Another aspect of the invention relates to the plurality of key input regions being dynamically updated at an update rate that corresponds to the rate of tilt detected.

Another aspect of the invention relates to each of the plurality of key input regions including a discrete display that is operable to display one or more user input symbols.

Another aspect of the invention relates to the plurality of key input regions sharing a common display and each key input region is operable to display one or more user input symbols.

Another aspect of the invention relates to available user input symbols for display on the plurality of key input regions being based on execution of an application by the electronic device.

Another aspect of the invention relates to the user input symbols including symbols that represent functions such that upon selection of the user input symbol that represents a function, the corresponding function is performed by the processor.

Another aspect of the invention relates to the plurality of key input regions being used for entering a telephone number and text input for a message.

Another aspect of the invention relates to a single user input symbol being displayed in each of the plurality of key input regions.

Another aspect of the invention relates to plurality of key input regions are mapped in the memory as a template that corresponds to a conventional QWERTY keyboard.

Another aspect of the invention relates to the display displaying the template of user input symbols for each of the plurality of key input regions.

One aspect of the invention relates to a method of entering symbols in an electronic device, the method including: detecting a tilt angle and/or a tilt rate of an electronic device by an accelerometer housed within the electronic device, wherein the accelerometer outputs an output signal corresponding to the detected tilt and/or tilt rate; and displaying a subset of user input symbols stored in a memory of the electronic device on a plurality of key input regions based on the detected tilt and/or tilt rate of the electronic device, wherein each key input region displays one user input symbol.

Another aspect of the invention relates to processing the detected tilt angle and/or tilt rate to determine a mapping of the user input symbols in the memory to each of the plurality of key input regions.

Another aspect of the invention relates to receiving a user input at one of the key input regions for selection of the user input symbol.

Another aspect of the invention relates to detecting the tilt angle and/or tilt rate of the electronic device after selection of the user input symbol and dynamically updating the plurality of key input regions based upon the detected tilt angle and/or tilt rate.

Another aspect of the invention relates to the dynamic update occurs by processing the detected tilt angle and/or tilt rate to determine a mapping of the user input symbols in the memory to update each of the plurality of key input regions.

Another aspect of the invention relates to the displayed subset of user input symbols is based at least partially on execution of an application program by the electronic device.

One aspect of the invention relates to a computer program stored on a machine readable medium in an electronic device, the program being suitable for dynamically displaying user input symbols on a plurality of key input regions by processing information received from motion detection circuitry to determine a tilt angle and/or a rate of tilt of the associated device, wherein the displayed user input symbols are indicative of the relative motion detected by the motion detection circuitry.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of one embodiment of a mobile telephone as an exemplary electronic device in accordance with the present invention.

FIG. 2 is a schematic block diagram of the relevant portions of the mobile telephone of FIG. 1.

FIG. 3 is a schematic diagram of a conventional QWERTY keyboard.

FIGS. 4A-4C are exemplary illustrations of detected motion and corresponding user input information displayed on key input regions in accordance with aspects of the present invention.

FIGS. 5A-5C are exemplary illustrations of detected motion and corresponding user input information displayed on key input regions in accordance with aspects of the present invention.

FIGS. 6A-6C are exemplary illustrations of detected motion and corresponding user input information displayed on key input regions in accordance with aspects of the present invention.

FIGS. 7A-7C are exemplary illustrations of detected motion and corresponding user input information displayed on key input regions in accordance with aspects of the present invention.

FIG. 8 is an exemplary method in accordance with aspects of the present invention.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smartphones, portable communication apparatus or the like.

In the present application, embodiments of the invention are described primarily in the context of a mobile telephone. However, it will be appreciated that the invention is not intended to be limited to the context of a mobile telephone and may relate to any type of appropriate electronic equipment, examples of which include a media player, a gaming device and a computer.

One aspect of the present invention relates to a mobile device having key input regions, e.g., a keypad. The key input regions may be discrete display elements, a common display, and/or use other mechanisms (e.g., a seven segment display) to change the appearance of the labels on and/or above the key input areas based upon orientation of the electronic device. For example, the electronic device may have motion detection circuitry (e.g., an accelerometer) to determine if the device is being tilted, a rate of tilt and/or if the tilt is changing (e.g., the user intends for tilt to be detected). Depending on the amount and/or rate of tilt, the key labels mapped to the detected tilt and/or rate of tilt are updated on the key input regions. The key input regions may be mapped to a conventional keypad. For example, a full tilt left will result in the key input regions displaying keypads that are mapped in memory to the left most keys of the keypad. Likewise, a full tilt right will result in the key input regions displaying labels that are mapped in memory to the right most keys on the keypad. A partial tilt will result in the keys changing according to the detection of the tilt based on the keypad template used to map the input symbols to the detected tilt based on the angle of tilt (e.g., the more severe the tilt the faster the labels on the key input regions will change). One of ordinary skill in the art will readily appreciate that a variety of repetitive tilt actions may also be supported. For example, it may be desirable to support repetitive tilt actions (e.g., tilt left/tilt left/tilt left means move three columns to the left), tilt right/tilt right/tilt right means move three columns to the right, etc.)

In general, operation assuming that a QWERTY keypad template is mapped to the detected tilt may be as follows: a user starts an application program with preferred QWERTY input operation. The key input regions may be preset as a conventional QWERTY keypad and/or include one or more keys that are user defined. Once the application is executing, the user begins to enter text. The user tilts the electronic device left or right as needed to bring a desired key label into view. For example, if the user wants to a “Q”, the user tilts the electronic device hard (e.g., a severe tilt) to the left and selects the key input area that displays the “Q”, assuming the key input regions are mapped in memory to a QWERTY keypad. If after that, the user wants to type a “T”, the user starts to tilt the electronic device back to the right until a key input area displays the “T”. The user may or may not have to fully tilt the electronic device to the right. As the user is tilting the device, the labels in the key input areas are updated. The invention may also be used to update other key labels and functions beyond the conventional QWERTY keypad.

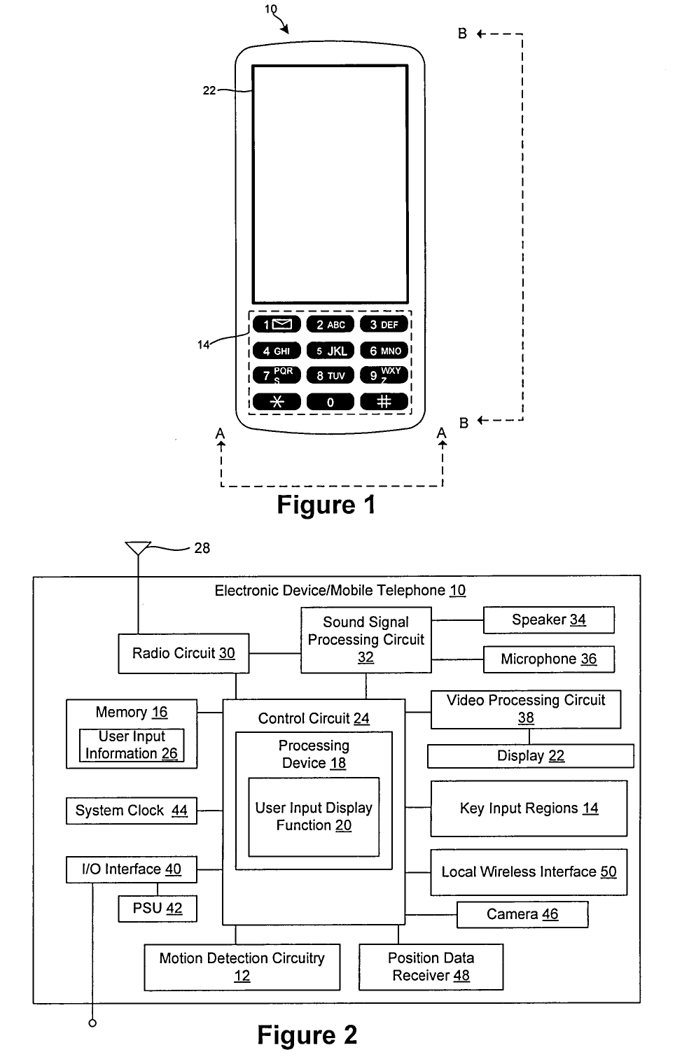

Referring initially to FIGS. 1 and 2, an exemplary portable electronic device 10 is shown. The electronic device 10 is configured with motion detection circuitry 12 that generates an output signal corresponding to a motion (e.g., a tilt, tilt rate, etc.) of the electronic device. The electronic device 10 has a plurality of key input regions 14 that display a subset of the user input symbols stored in memory 16, as discussed below. A processor 18 is coupled to the motion detection circuitry 12, the plurality of key input regions 14 and the memory 16 to process the output signal of the motion detection circuitry 12 and causes the electronic device to dynamically display a subset of user input symbols on the plurality of key input regions 14 based on the output signal of the motion detection circuitry 12.

The electronic device 10 may include a user input display function 20 that utilizes the output signal generated by the motion detection circuitry 12 to change the labels associated with the plurality of key input regions 14. The user input display function 20 may be embodied as executable code that is resident in and executed by the electronic device 10. In one embodiment, the user input display function 20 may be a program stored on a computer or machine readable medium. The user input display function 20 may be a stand-alone software application or form a part of a software application that carries out additional tasks related to the electronic device 10. The user input display function 20 may be stored in memory 16 and/or in firmware.

The electronic device 10 of the illustrated embodiment is a mobile telephone and will be referred to as the mobile telephone 10. The mobile telephone 10 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

The mobile telephone 10 includes a display 22. The display 22 displays information to a user such as operating state, time, telephone numbers, contact information, various navigational menus, etc., through a graphical user interface (GUI) that enables the user to utilize the various features of the mobile telephone 10. The display 22 also may be used to visually display content received by the mobile telephone 10 and/or retrieved from a memory 16 (FIG. 2) of the mobile telephone 10. The display 22 may be used to present symbols, text information, functional representations, images, video and other graphics to the user, such as photographs, mobile television content and video associated with games.

The plurality of key input regions 14 (also referred to herein as a “keypad”) facilitate controlling operation of the mobile telephone 10 by allowing for entry of alphanumeric information, such as telephone numbers, phone lists, contact information, text messages, e-mail messages, notes and the like. The plurality of key input regions 14 generally comprises fewer key input regions than available letter in the English alphabet, for example. As shown in FIG. 1, the plurality of key input regions 14 is a 4×3 array. The labels over the key input regions 14 may vary based on the application executed by the electronic device 10. One of ordinary skill in the art will appreciate that the number and configuration of key input regions may be varied and each variation shall fall within the scope of the present invention.

The plurality key input regions 14 may also include special function keys such as a “call send” key for initiating or answering a call, and a “call end” key for ending or “hanging up” a call. Special function keys also may include menu navigation and select keys to facilitate navigating through a menu displayed on the display 22. For instance, a pointing device and/or navigation keys (not shown) may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, any other dedicated on non-dedicated control key, etc. Keys or key-like functionality also may be embodied as a touch screen associated with the display 22. Also, the display 22 and key input regions 14 may be used in conjunction with one another to implement soft key functionality (e.g., when the display 22 is a touchscreen).

The plurality key input regions 14 may be separate from the display 22, may be formed partially by the display, or may be formed completely by the display 22 (e.g., as a portion of a touchscreen). When the plurality key input regions 14 are formed as part of the display or completely by the display 22, the display 22 dynamically changes the label of the key input regions 14 in response to the motion detection circuitry 12. When the plurality key input regions 14 is separate from the display 22, the key input regions 14 may include display elements (e.g., discrete liquid crystal display elements, seven-segment LCD, etc.) that dynamically change the display elements in response to the motion detection circuitry 12.

The display 22 may also display the current keyboard mapping for all of the plurality of key input regions. That is, the display may display the entire template of user input symbols for each of the plurality of key input regions. The display of such information will enable a user to easily viewer to view the active labels, and inactive labels. The display of such information will also provide a convenient reference for user trying to find another user input symbol among all of the user input symbols available on a particular template.

The mobile telephone 10 may include call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 10 may be configured to transmit, receive and/or process data, such as text messages (e.g., a text message is commonly referred to by some as “an SMS,” which stands for short message service), instant messages, electronic mail messages, multimedia messages (e.g., a multimedia message is commonly referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

FIG. 2 represents a functional block diagram of the mobile telephone 10. For the sake of brevity, generally conventional features of the mobile telephone 10 will not be described in great detail herein. The mobile telephone 10 includes a primary control circuit 24 that is configured to carry out overall control of the functions and operations of the mobile telephone 10. The control circuit 24 may include a processing device 18, such as a CPU, microcontroller or microprocessor. The processing device 18 executes code stored in a memory (not shown) within the control circuit 24 and/or in a separate memory, such as the memory 16, in order to carry out operation of the mobile telephone 10. The memory 16 may be, for example, one or more of a buffer, a flash memory, a hard drive, a removable media, a volatile memory, a non-volatile memory, a random access memory (RAM), or other suitable device.

The memory 16 generally includes user input information 26. For example, the user input information 26 may include symbols (e.g., alphanumeric characters, graphical representations of functions, etc.) and one or more templates, which may include a configuration of one or more conventional keyboards (e.g., QWERTY, Dvorak Simplified Keyboard, Colemak, etc.). Generally, the user input information 26 is mapped in the memory 16 to a lookup table or other mapping structure, such that the output of the motion detection circuitry 12 corresponds to certain user input information 26 being displayed on the key input regions 14.

The processing device 18 may execute code that implements the user input display function 20. It will be apparent to a person having ordinary skill in the art of computer programming, and specifically in application programming for mobile telephones or other electronic devices, how to program a mobile telephone 10 to operate and carry out logical functions associated with the user input display function 20. Accordingly, details as to specific programming code have been left out for the sake of brevity. Also, while the user input display function 20 is executed by the processing device 18 in accordance with a preferred embodiment of the invention, such functionality could also be carried out via dedicated hardware, firmware, software, or combinations thereof, without departing from the scope of the invention.

Continuing to refer to FIGS. 1 and 2, the mobile telephone 10 includes an antenna 28 coupled to a radio circuit 30. The radio circuit 30 includes a radio frequency transmitter and receiver for transmitting and receiving signals via the antenna 28 as is conventional. The radio circuit 30 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 32 for processing audio signals transmitted by and received from the radio circuit 30. Coupled to the sound processing circuit 32 are a speaker 34 and a microphone 36 that enable a user to listen and speak via the mobile telephone 10 as is conventional. The radio circuit 30 and sound processing circuit 32 are each coupled to the control circuit 24 so as to carry out overall operation. Audio data may be passed from the control circuit 24 to the sound signal processing circuit 32 for playback to the user. The audio data may include, for example, audio data from an audio file stored by the memory 16 and retrieved by the control circuit 24, or received audio data such as in the form of streaming audio data from a mobile radio service. The sound processing circuit 32 may include any appropriate buffers, decoders, amplifiers and so forth.

The display 22 may be coupled to the control circuit 24 by a video processing circuit 38 that converts video data to a video signal used to drive the display 22. The video processing circuit 38 may include any appropriate buffers, decoders, video data processors and so forth. The video data may be generated by the control circuit 24, retrieved from a video file that is stored in the memory 16, derived from an incoming video data stream that is received by the radio circuit 30 or obtained by any other suitable method.

The mobile telephone 10 may further include one or more I/O interface(s) 40. The I/O interface(s) 40 may be in the form of typical mobile telephone I/O interfaces and may include one or more electrical connectors. As is typical, the I/O interface(s) 40 may be used to couple the mobile telephone 10 to a battery charger to charge a battery of a power supply unit (PSU) 42 within the mobile telephone 10. In addition, or in the alternative, the I/O interface(s) 42 may serve to connect the mobile telephone 10 to a headset assembly (e.g., a personal handsfree (PHF) device) that has a wired interface with the mobile telephone 10. Further, the I/O interface(s) 40 may serve to connect the mobile telephone 10 to a personal computer or other device via a data cable for the exchange of data. The mobile telephone 10 may receive operating power via the I/O interface(s) 40 when connected to a vehicle power adapter or an electricity outlet power adapter.

The mobile telephone 10 also may include a system clock 44 for clocking the various components of the mobile telephone 10, such as the control circuit 24. The control circuit 24 may, in turn, carry out timing functions, such as timing the durations of calls, generating the content of time and date stamps, and so forth.

The mobile telephone 10 may include a camera 46 for taking digital pictures and/or movies. Image and/or video files corresponding to the pictures and/or movies may be stored in the memory 16 or an external storage device. The mobile telephone 10 also may include a position data receiver 48, such as a global positioning system (GPS) receiver, Galileo satellite system receiver or the like. The position data receiver 48 may be involved in ascertaining the location of the mobile telephone 10. The determination of the location of the mobile telephone 10 will be described in greater detail below.

The mobile telephone 10 also may include a local wireless interface 50, such as an infrared transceiver and/or an RF interface (e.g., a Bluetooth interface), for establishing communication with an accessory, another mobile radio terminal, a computer or another device. For example, the local wireless interface 50 may operatively couple the mobile telephone 10 to a headset assembly (e.g., a PHF device) in an embodiment where the headset assembly has a corresponding wireless interface.

As stated above, the mobile telephone 10 also includes motion detection circuitry 12. The motion detection circuitry may be any type of circuitry and/or device that is capable of detecting absolute and/or relative motion of the mobile telephone 10. The motion detection circuitry 12 may be a contact-less sensor, a single sensor, a plurality of sensors and/or an array of sensors. The phrase “motion detection circuitry” is intended to be interpreted broadly to include any type of sensor, any number of sensors and/or any arrangement of sensors that is capable of detecting motion in a horizontal, vertical plane and/or combination of horizontal and vertical planes (also referred to herein as movement), of the mobile telephone 10. Motion may also be detected as a roll, pitch and/or yaw. For example, horizontal motion might equate to a roll, pitch and/or yaw.

Exemplary sensors may include accelerometers, speedometers, velocitometers, gyroscopes, etc. The motion detection circuitry 12 may be located in any desirable position or positions on the mobile telephone 10. The location of the motion detection circuitry 12 may vary based on a number of design considerations. Such design considerations include, for example, the type of sensors used, the number of sensors, the size and shape of the electronic device, the type of motion being detected, etc. For example, the motion detection circuitry 12 in the form of a single or multiple accelerometers may be housed internally of the mobile telephone 10 to determine absolute and/or relative movement of the mobile telephone 10. One or more sensors may be located in various portions of the mobile telephone 10 to detect a relative motion between the sensors.

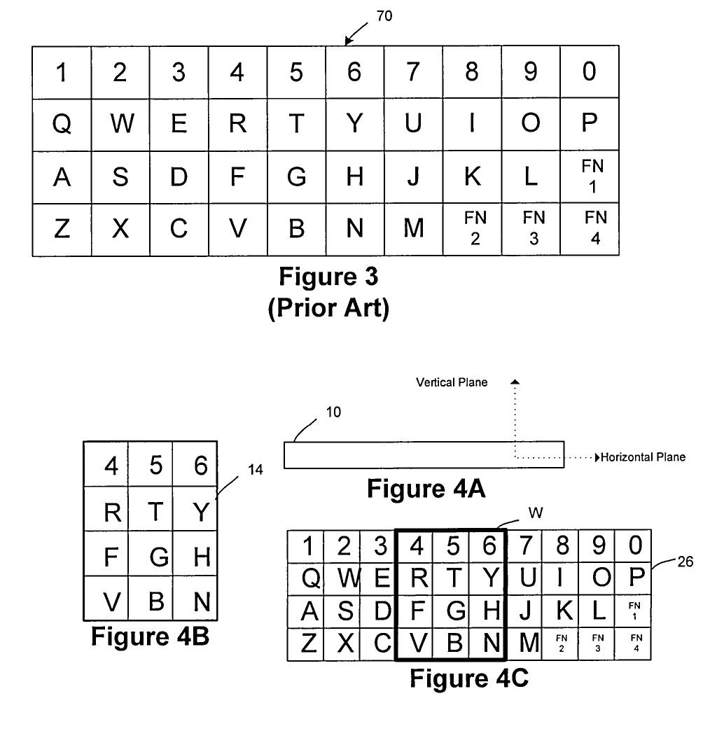

Referring to FIG. 3, an exemplary QWERTY keypad 70 is illustrated. The exemplary keypad 70 includes four (4) rows and ten (10) columns. The keypad 70 includes all 26 letters of the English alphabet, the numbers 0-9 and other function keys (FN1-FN4). Each of the keys are located on separate key input regions (e.g., on separate buttons). In operation, the user simply presses and de-presses the desired key for selection of the desired symbol. The function keys may used to initiate a pre-defined and/or user-defined function. Such functions may include, for example, a return function, shift key, control key, CAPS lock key, punctuation characters, etc. One of ordinary skill in the art will appreciate that the QWERTY keypad 70 is exemplary in nature and may vary from one keypad to another keypad.

FIG. 4A illustrates a profile of the mobile telephone 10 viewed along lines A-A of FIG. 1. As shown in FIG. 4A, the mobile telephone is held substantially level (or parallel to a horizontal plane) and substantially perpendicular to a vertical plane. In such a position, the mobile telephone is in a neutral position (i.e., that is the mobile device is not tilted in either a vertical direction or a horizontal direction). Therefore, the motion detection circuitry outputs a signal that the mobile telephone 10 is substantially level and/or not tilted in the horizontal plane. Such a reference position may be absolute where the device is perfectly flat in the horizontal plane, for example. In another embodiment, the user may set the reference position (e.g, a position that the user is comfortable handling the device, which may or may not be perfectly flat. The selection of the reference position may be set by a user pressing a button on the keypad to establish the reference position.

In the neutral position, the output of the plurality of key input regions 14 may be illustrated in FIG. 4B. Referring to FIG. 4B, the user input symbols “4”, “5”, “6”, “R”, “T”, “Y”, “F”, “G”, “H”, “V”, “B” and “N” may be displayed to the user for selection in entering a message. An exemplary mapping of the user input information 26 corresponding to the detected motion is illustrated in FIG. 4C. FIG. 4C illustrates a template stored, as part of the user input information 26 stored in memory 16. The exemplary template is a conventional QWERTY keypad. The window (W) (illustrated as a box having bold lines) depicts the active region (e.g., displayed region on the key input regions 14).

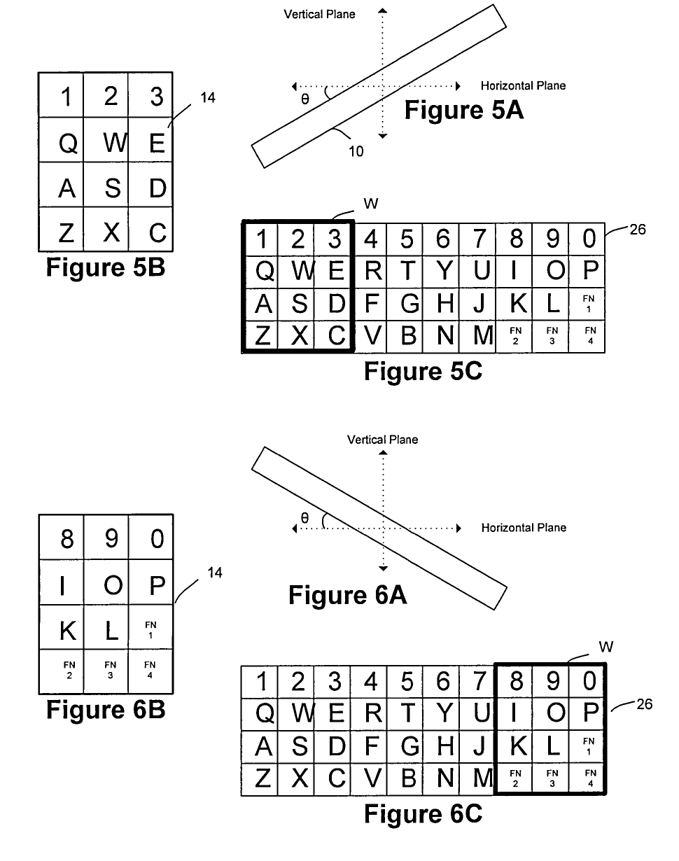

As the motion detection circuitry detects movement (e.g., tilting of the electronic device), the window (W) may move based on the detected motion of the motion detection circuitry and the key input regions 14 will update accordingly. For example, if the motion detection circuitry detects that the device has been tilted to the left by an angle θ, as shown in FIG. 5A, the plurality of key input regions 14 will be updated to output the symbols of the user input information 26 to the user for selection that correspond to the detected motion. FIG. 5C, conceptually illustrates window (W) moving to the left, which corresponds to the detected movement of the mobile telephone 10 by the motion detection circuitry 12 and displays the corresponding user input information on the key input regions 14 (FIG. 5B).

If the user then tilts the mobile telephone to the right by the angle θ, as shown in FIG. 6A, the user input regions 14 that correspond to the detected motion are displayed. Conceptually, the window (W) may move to the right end of template, as shown in FIG. 5C, which corresponds to the rightmost symbols of the template being displayed on the key input regions 14 for selection by a user, as shown in FIG. 5B.

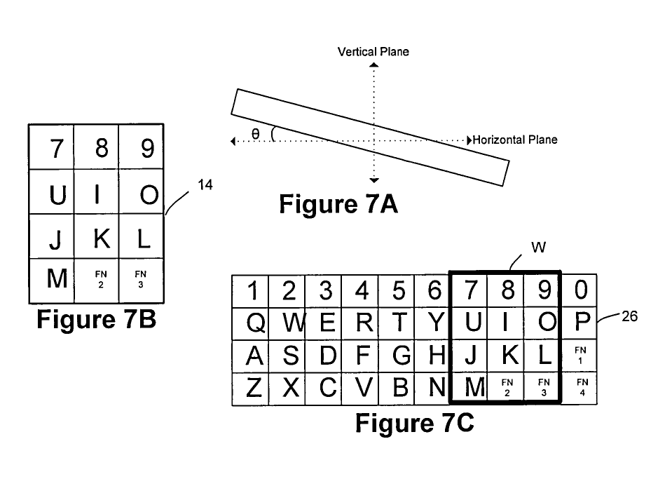

From FIG. 6C, if the user tilts the mobile telephone slightly to the left (angle θ), the window (W) may move slightly to the left based on the detected motion from the motion detection circuitry 12. For example, as shown in FIG. 7A, the angle of tilt (θ) is significantly less than the angle θ illustrated in FIG. 6A. This results in the plurality of key input regions 14 displaying the user input symbols mapped to the corresponding motion at a slower refresh rate. Conceptually this may be viewed as the window (W) slowly moving from its prior position (FIG. 6C) to another position based on the detected tilt, as shown in FIG. 7C. The plurality of key input regions 14 is updated as illustrated in FIG. 7B, such that symbols that correspond to the detected motion are displayed to the user for selection. Likewise, if the angle of tilt θ is large, the key input regions 14 may change at a faster rate than when a smaller angle of tilt θ is detected. Similarly, the key input regions may be update based upon the detected rate of tilt. For example, if a fast rate of tilt is detected, the key input regions 14 may update at a faster rate than if a slow rate of tilt is detected and vice versa. Accordingly, the plurality of key input regions being may be dynamically updated at an update rate that corresponds to the rate of tilt detected. One of ordinary skill in the art will appreciate that the update rate may be delayed to account for hysteresis (e.g., to prevent the labels from changing too quickly).

The above examples are exemplary in nature and not intended to limit the scope of the present invention. One of ordinary skill in the art will readily appreciate that while the embodiments discussed above illustrate tilt and/or tilt rate in a horizontal plane (e.g., left to right and/or right to left), tilt and/or tilt rate of the mobile telephone may also be measured by tilting the mobile telephone front to back and/or back to front, along lines B-B illustrated in FIG. 1. Such functionality is particularly warranted if a particular template has more rows than the number of rows of key input regions provided on the mobile telephone.

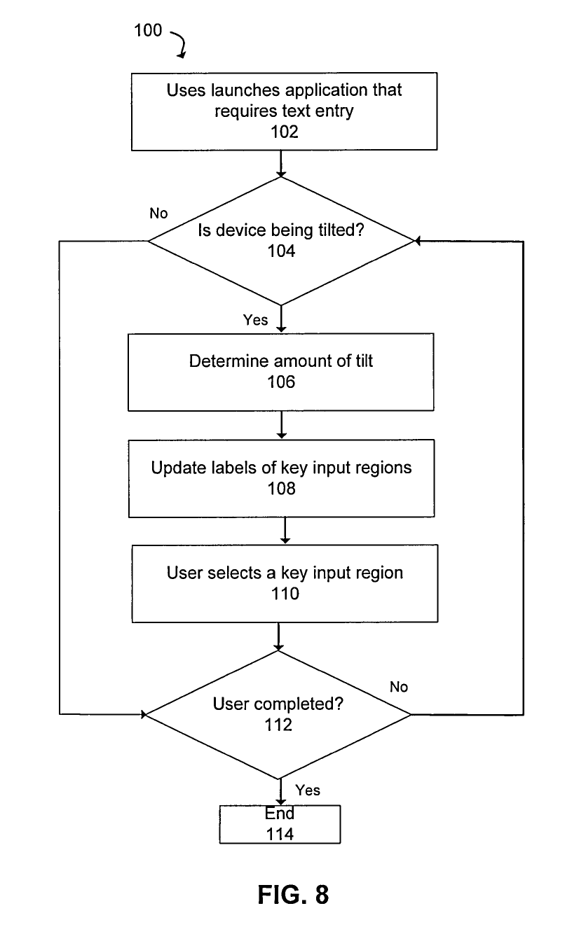

With additional reference to FIG. 8, an exemplary method 100 for updating key input regions 14 based on the detected motion of the mobile telephone. At block 102, the user may select or launch an application on the mobile telephone 10 that requires text entry. Prior to launching the application, the mobile telephone may display a keypad in a conventional manner, as illustrated in FIG. 1. Upon execution of the application, a default keypad may be displayed as shown in FIG. 4B.

At block 104, a determination is made as to whether the mobile telephone 10 is being titled in one or more planes. Such a determination may be made by the motion detection circuitry 12. The motion detection circuitry 12 generally outputs an output signal corresponding to a detected motion of the mobile telephone 10. As stated above, the motion detection circuitry 12 may be hardware, software, firmware and/or any combination of hardware, software or firmware. For example, the motion detection circuitry may be one or more sensors that calculate acceleration (e.g., an accelerometer, etc.) velocity (e.g., speedometer, velocitometer, etc.) and/or position (e.g., gyroscope) of the mobile telephone. If no tilt is detected after a certain amount of time program flow may proceed to block 112.

At block 106, the amount of tilt and/or tilt rate of the mobile telephone is determined. Such a determination may be made directly from the motion detection circuitry and/or determined by processing by the control circuit 24.

At block 108, the labels for one or more of the key input regions 14 are update based on the detected motion and the corresponding mapping of the user input information 26 in the memory 16.

At block 110, the user presses a key input region to enter the user input symbol. Upon selection of the user input symbol, the selected symbol may be displayed on the display 22. In addition, a cursor or other indication displayed on the display 22 may move to the next position for entry of the next symbol. In another embodiment, when the user selects an input symbol that represents an application function, the corresponding function is performed by the processor 18.

At block 112, if the user has completed entering the message or application intent, the method 100 may terminate at block 114. Otherwise, the program flow returns to block 104 to determine if the mobile telephone as been tilted for entry of the next user input symbol.

The exemplary method may be carried out by executing an embodiment of the user input display function 20, for example. Thus, the flow chart of FIG. 8 may be thought of as depicting steps of a method carried out by the mobile telephone 10. Although FIG. 8 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

One of ordinary skill in the art will readily appreciate that the above description is illustrative in nature and one or more of the key input regions 14 may be associated with different symbols and/or functions and/or icons. In addition, a user may configure the keypad 10 to include user defined symbols and/or frequently used texting symbols and/or words. The user may also customize the distribution of icons and/or characters in any desired manner. For example, the key input regions 14 may vary depending on one or more software applications being executed by the mobile telephone 10 (e.g., functions (rewind, play, pause, fast forward, skip, etc) associated with a player may be displayed on the key input regions if a multimedia player application is being executed by the mobile telephone).

A person having ordinary skill in the art of computer programming and/or circuit design, and specifically in applications programming for mobile phones, will be able to program a mobile phone to operate and carry out the functions described herein with respect to the user interaction provided by the user input display function 20 in view of the provided description. Accordingly, details as to the specific programming code have been left out for the sake of brevity.

While for purposes of simplicity of explanation, the flow charts or functional diagrams in the following figures include a series of steps or functional blocks that represent one or more aspects of the relevant operation of the mobile telephone 10. It is to be understood and appreciated that aspects of the invention described herein are not limited to the order of steps or functional blocks, as some steps or functional blocks may, in accordance with aspects of the present invention occur in different orders and/or concurrently with other steps or functional blocks from that shown or described herein. Moreover, not all illustrated steps or functional blocks of aspects of relevant operation may be required to implement a methodology in accordance with an aspect of the invention. Furthermore, additional steps or functional blocks representative of aspects of relevant operation may be added without departing from the scope of the present invention.

Although the invention has been shown and described with respect to a certain preferred embodiment or embodiments, it is understood that equivalents and modifications will occur to others skilled in the art upon the reading and understanding of this specification and the annexed drawings. The present invention includes all such modifications, and is limited only by the scope of the following claims.

What is claimed is:

1. An electronic device comprising:
a memory for storing user input symbols;
a plurality of key input regions that display a subset of the user input symbols available in the memory;
motion detection circuitry configured to detect motion of the electronic device and generate an output signal corresponding to the detected motion; and
a processor coupled to the motion detection circuitry, the plurality of key input regions and the memory, wherein the processor processes the output signal of the motion detection circuitry and dynamically displays the subset of user input symbols on the plurality of key input regions based on the output signal of the motion detection circuitry.

2. The electronic device of claim 1, wherein the motion detection circuitry includes an accelerometer.

3. The electronic device of claim 1, wherein the output signal of the motion detection circuitry corresponds to a relative tilt angle of the electronic device.

4. The electronic device of any of claims 1-3, wherein the output signal of the motion detection circuitry corresponds to a rate of tilt associated with the electronic device.

5. The electronic device of claim 4, wherein the plurality of key input regions are dynamically updated at an update rate that corresponds to the rate of tilt detected.

6. The electronic device any one of claims 1-5, wherein each of the plurality of key input regions include a discrete display that is operable to display one or more user input symbols.

7. The electronic device of any one of claim 1-5, wherein the plurality of key input regions share a common display and each key input region is operable to display one or more user input symbols.

8. The electronic device of any one of claims 1-7, wherein available user input symbols for display on the plurality of key input regions are based on execution of an application by the electronic device.

9. The electronic device of any one of claims 1-8, wherein the user input symbols include symbols that represent functions such that upon selection of the user input symbol that represents a function, the corresponding function is performed by the processor.

10. The electronic device of any one of claims 1-9, wherein the plurality of key input regions are used for entering a telephone number and text input for a message.

11. The electronic device of any one of claims 1-10, wherein a single user input symbol is displayed in each of the plurality of key input regions.

12. The electronic device of any one of claims 1-11, wherein the plurality of key input regions are mapped in the memory as a template that corresponds to a conventional QWERTY keyboard.

13. The electronic device of 12, wherein the display displays the template of user input symbols for each of the plurality of key input regions.

14. A method of entering symbols in an electronic device, the method comprising:
detecting a tilt angle and/or a tilt rate of an electronic device by an accelerometer housed within the electronic device, wherein the accelerometer outputs an output signal corresponding to the detected tilt and/or tilt rate; and
displaying a subset of user input symbols stored in a memory of the electronic device on a plurality of key input regions based on the detected tilt and/or tilt rate of the electronic device, wherein each key input region displays one user input symbol.

15. The method of claim 14 further including processing the detected tilt angle and/or tilt rate to determine a mapping of the user input symbols in the memory to each of the plurality of key input regions.

16. The method of any one of claims 14-15 further including receiving a user input at one of the key input regions for selection of the user input symbol.

17. The method of any one of claim 14-16 further detecting the tilt angle and/or tilt rate of the electronic device after selection of the user input symbol and dynamically updating the plurality of key input regions based upon the detected tilt angle and/or tilt rate.

18. The method of claim 17, wherein the dynamic update occurs by processing the detected tilt angle and/or tilt rate to determine a mapping of the user input symbols in the memory to update each of the plurality of key input regions.

19. The method of any one of claims 14-18, wherein the displayed subset of user input symbols is based at least partially on execution of an application program by the electronic device.

20. A computer program stored on a machine readable medium in an electronic device, the program being suitable for dynamically displaying user input symbols on a plurality of key input regions by processing information received from motion detection circuitry to determine a tilt angle and/or a rate of tilt of the associated device, wherein the displayed user input symbols are indicative of the relative motion detected by the motion detection circuitry.
